(19) United States
(12) Patent Application Publication
(10) Pub. No.: US 2017/0018045 A1
(43) Pub. Date: Jan. 19, 2017

(54) Quality community review (QCR)

(71) Applicant: Geraldine Patricia Hunter, Huntersville, NC (US)

(72) Inventor: Geraldine Patricia Hunter, Huntersville, NC (US)

(21) Appl. No.: 14/545,959

(22) Filed: Jul. 13, 2015

(51) Int. Cl. G06Q 50/16

(52) U.S. Cl. CPC G06Q 50/16

(57) ABSTRACT

I have considered and developed this invention (QCR) over a 30 year span and it hasn't been until recent technological advances have allowed for me to put it all into a technical format. This (via the website, phone apps, and Global Positioning Service (GPS)) invention (QCR) will be a format and a tool for home buyers and home sellers. It will enable For Sale by Owner (FSBO's); Realtors; Buyers and Sellers to access information on communities that is essentially not completely available or thought about until the new home buyer is in the home. This is the ‘Community Information’ in a technical format readily available and rated and based on expert and industry standards. The basis of the QCR will be three fold; the legal ascept, governing documents; the Leaders of the community, Board of Directors; and the existing homeowners, the new buyer's ‘future neighbors’. I believe homebuyers should consider the community in which they are about to purchase a house in very, very carefully, which most time this is overlooked. As buyers have so much to think about when purchasing a home such as house size, school districts, roof styles, bedroom size, very often they don't consider what the feel of actually living within that neighborhood and community will feel like. Now through our research and testimonials the QCR will give them a ‘glimpse’ of the actual community before they put an offer on the home or buy within that community. Buyers driving through a community will be able to engage the QCR info via a phone ap or website on a laptop, just by a Geo Location function and read the ratings on the community they just drove through without even knowing the name of the community.

I have worked, both, within the Real Estate Industry as a Broker and the HOA/Community Industry as a Community Manager. Having spent many years in each industry, I can say that they are always seen as two separate industries, by both sides that never meet up. The Real Estate agent is no longer in the picture when after the new home owner has spent their first month in the home and then after. Following that the Community Manager enters as the source of information for the community. Often times the home buyer has incorrect community information that was inadvertently passed along. Home buyers miss out because of this division and loose out in the passage of information. Now I can bring the QCR to the market place as a Bridge between two separated and completely divided industries. The OCR will be an ‘in between bridge’ from the Real Estate Market to the HOA/Community Market. Home buyers will be more informed about what their purchase will truly completely entail.

In addition to having spent many years as a real estate broker, I have also spent many years as an HOA & community manager. I can say that I have witnessed first had what the lack of community knowledge can do to a home buyer. I have seen where homeowners have had to remove brand new roofs at $6000 plus because they didn't get the correct approval and picked the wrong type of shingle. I have also seen where a family had to surrender two Rottweiler puppies because they didn't check that their governing documents had a Breed Restriction for Rottweilers. This are just a few of examples, but there are many.

Chances are even you, as the reader of this patent application, live in a community with governing documents. Wouldn't it be a huge advantage if you had a quick reference check for community restrictions. I believe so, that is why I created the QCR.

US—App No. 62/070,823 Provisional

Previous Filing Date for Provisional Sep. 8, 2014

At this time, this present invention and Provisional Patent is being submitted for a Patent.

### I. Outline

This invention and system will provide for a home buyer a method of evaluating communities by way of various rating methods where a house is to be purchased prior to purchase. It includes: a financial review, legal review, and community testimonials.

Quality Community Review, hereafter called ‘QCR’, will be an aid to provide information and a community profile with a rating system to potential home buyers (known as ‘susbscribers’) purchasing within a community with governing documents and/or homeowner assessments or even a community that has no binding documents.

The below system will be used or transferred via or along with an application/website for the computer; internet; mobile phone, mobile application and other yet to be developed methods. The QCR will be also available to customers in paper copy upon request.

‘Community’ hereafter known as and will include all of the following but not limited to: Homeowners Association (HOA); Condominium Association (COA); Property Owners Association (POA); Co-Operative Ownership Associations (Co-Op); Mobile Home Communities and any additional communities that so want to be included.

‘Community Consultant’ will be an independent third party person who is responsible for verifying the data and information submitted or provided for each community.

‘Readers’ will be a researcher who reads through the documents and reports on discrepancies within the documents, governing restrictions, verifies recording dates, etc.

Each community in the database will have its own community number assigned, and a community profile called a Quality Community Review—QCR entered into the QRC system and will be based on the factors as outlined within this Patent Application—Description.

It is noted that a variety of methods (known today) are to be used to acquire the data, transfer, and download into this QCR database and system. According to known techniques and technology, today, the methods known that will be and are considered for use are: electronic mail (e-mail); Simple Mail Transfer Protocol (SMTP); File Transfer Protocol (FTP); Hyper Text Transfer Protocol (HTTP); the Internets'—TCP/IP; XML; JAVA applications, GPS or Geo Location, and mobile phone app's. These, today known methods but not limited to, will be used to accomplish the format and end result of this QCR invention.

This Quality Community Review (QCR) will be an aid to subscribers when purchasing a home in a community with a membership to an association, with governing documents, and/or annual assessments or any outlined community. The QRC will supply and provide detailed information about the community that is typically not discovered until after the homebuyer/subscriber moves into the community. It will essentially be a community profile. Additionally, buyers can drive through a community and access info to the governing doc's and restrictions without even knowing the name of the community via a GPS or Geo Locator.

The QCR will be an overall rating of the community based on many factors and (where needed) an expert opinion delivered by an expert in this field and industry. This will be a expert verified report ‘Verified’. There will be an option for a second method of completing a community profile that is not expert verified. That is with an option for a community Board member or homeowner to self-down load information and these documents that will be reviewed for accuracy by a Community Consultant.

So to be clear, there will be a few methods of creating a community profile within the database.

In the present invention, the computer generated community database of ‘evaluated communities’, QCR System, will encompass communities of: homes/Single Family Dwellings, condominiums, co-operatives, mobile homes for consideration of evaluation and will be listed within a system and database that potential buyers can retrieve the relevant community information that is pertinent per the governing documents and below listed additional factors. This information will be outlined in a community profile called a Quality Community Review—‘OCR.’

The QCR will include and is not limited to: additional community feature information: direct homeowner testimonials, financial information and/or budget, legal information such as the main governing documents and a listing of the main restrictions (or a portion of up to approximately 10 of the most important community restrictions, unless more are needed) for that said community.

Additionally, the important status of Board control will be in this QCR: ie. developer involvement ‘Developer controlled HOA Board of Directors or Homeowner controlled HOA Board of Directors.’

A brief overview of the entire community will be in the introduction section: for example, ‘Location—north of metro area; 338 homes; 2500 to 3600 sq. ft.; price range $228,000 to $425,000. Current annual association assessments per house: $558.00.’

Quality Community Review, ‘QCR’, will be a third party evaluation of each community within the community database. It will be a community profile for each community with a rating system.

There will be a final 1 to 10 score rating appointed to each community section that is reviewed and outlined by the Community Consultant.

Each U.S.A. state is different and they use different government levels (City, County, or State) to approve and record the communities governing documents. In most states (or at least the ones I have lived in) each County records these documents. For purposes of this patent application we will assume each state uses their own counties for this function of recording the communities documents (Articles Of Incorporation; By-Laws; Declaration of Covenants, Conditions, and Restrictions). Each state may call these documents something of the same name or near the same name, but they are the communities governing documents.

Once the community profile is generated in the database a subscriber will be able to retrieve this profile/QCR and their individual rating. The community profile supplied via the QCR to potential subscribers will be a web or application (smart phone) or paper copy based report, the ‘QCR’, of the said community and listed in the QCR database.

Each community profile will be reviewed and evaluated by the third party manager, ‘Community Consultant’, generally employed by the QCR company with no interest of the subject community.

Each community area and category, as defined below, will be evaluated and given a rating from a high excellent to sufficient to low rating such as: a number between 1 to 10 rating, with 10 being the best and highest score. Note: It may be a sliding color scale or numbers from 1100 to 1900. For purposes of this patent application and description a number rating system from 1 to 10 will be used. Each section will be assigned a number based on the individual section then averaged for a combined final score. An example is on page 19.

### II. Evaluation of Categories of Communities

The evaluation and community profile (QCR) will be based on reviews of the following:
1) governing documents, rules and regulations, and adopted resolutions;
2) budget, financials, audit and/or reserve information;
3) said policies and follow through of acting current and past Board of Directors, committee chairs, and the Architectural Control Committee
4) community property management company selection, history with community, and their performance
5) amenities and their life expectancy, additionally whether all planned amenities have been installed per the original community layout
6) testimonials from individual property owners, **additionally this will be monitored and checked for foul language or foul comments. Then if needed it will be deleted by the Community Consultant
7) areas of concern, ie. aging out of community, pending lawsuits

Additionally, these above factors and the assigned ratings will be an indication and evaluation of how the community is managed by the volunteers, self managed, and/or the employed association management company. This QCR will be a guideline for any potential subscribers as to the current association management style and method of carrying out the daily operations of the community. The QCR will also flag any potential issues for consideration by a potential home buyer/subscriber that may be of a concern to them in regards to their purchase and their own individual lifestyle. For example, ‘Does the community allow above ground pools? Perhaps the potential home buyer/subscriber wants to install one or perhaps they consider this to be an eyesore.’ Or “Are boats allowed to be parked in the driveway? Again subscriber may find this an eyesore or maybe they want to store their boat in a driveway.” The QCR will provide this type of valued information. Often times, this type of information is not past through from the home seller to home buyer/subscriber.

Below are the main categories of each community association that will be reviewed and evaluated then rated by a third party consultant.
Name of Review Sections
   1. A. Document Review
   2. B. Financial Review
   3. C. Committee Performance Review
   4. D. Management Company Performance Review & History
   5. E. Community Amenities Review
   6. F. Meet the Community Neighbors!
   7. G. Additional Notes

**End of the introduction and overview of QCR.

### III. More Detail Information Below Regarding Each ‘Review’ Section

### A. Governing Documents, Rules and Regulations, and Adopted Resolution—

### Document Review

All primary documents will be listed in this section and they are typically noted as: Articles of Incorporation; By Laws; Declaration of Convenants, Conditions, and Restrictions (CCR's). There may also be added secondary documents: Rules and Regulations; Architectural Review Guide; Board Resolutions.

All documents for each individual community may be researched by a practicing HOA attorney versed in this industry. This will enable this section to be marked “Verified”. This attorney will be responsible for ensuring the current correct filed and recorded governing community documents are submitted for downloading onto the QCR site. (My experience often times the wrong outdated documents are presented to home buyers.) Official dates will be established in the QCR system when documents are ‘Verified’ and this will be noted so that it is clear as to when the documents were loaded on what date onto the QCR system.

This will be noted as, ie. ‘On Mar. 18, 2009 these recorded Happy Trail Condominium Documents dated recorded Feb.22, 1992 in the Rainbow County of North Carolina being such as community documents for Happy Trails Condominium were reviewed and loaded on to this QCR site by the HOA attorney Mike H. of HY Law Firm for full review. **Information ‘Verified ’

NOTE: Or if a community does not want to incur the anticipated legal fee for an attorney to research, review, and submit for downloading the official community documents the Board can opt to have the Board President or a Board Member submit these documents for downloading with the following example of information, ie. ‘Board of Directors submitted: On Mar. 18, 2009 the attached community documents for Happy Trails Condominium were submitted & loaded on to this QCR site by the currently elected Board President—John Smith.’ Note: in this example there will be no ‘Verified’ symbol.

In regards to secondary documents the following will apply: Rules and Regulation and any Adopted Resolutions will be noted. These additional documents will be downloaded onto the QCR with dates of Board adoption. If not available for download, must be noted that they exist, ie. ‘Community Consultant was told that a new resolution(or Rules and Regulations) was approved. As of today's date that document is not available for download on to the QCR. If needed please contact QCR representative.’

Please note: it must be noted in the QCR if these additional documents Rules and Regulations, Architectural Design Guide, and/or Board Resolutions are recorded with the County.

If an HOA attorney does review the primary documents, these Covenants, Conditions, and Restrictions and all other community documents shall be reviewed for any discrepancies or overlapping. If any discrepancies are found, these are to be noted on the QCR web site in a section called “Document Review—notes”. For example, ‘As noted on Jun. 3, 1998—original developer stated he would install a playground, but only a park bench and mulch were installed by Developer near back woods. This is being noted that this was omitted by the original developer.’

Another example, ‘As being noted by 3^{rd} party Community Consultant, the original developer also built a 2^{nd} phase, Jenny's Glen 2, next to this subject property named Jenny's Glen. The 2^{nd} phase, named Jenny's Glen 2, is not incorporated into the original phase 1, Jenny Glen. Please note Jenny's Glen phase 1 has a community pool and Jenny's Glen 2 is not part of Jenny's Glen 1 and does not have a pool. Therefore Jenny Glen 2 residents do NOT have pool privileges.’

Other potential examples for notes:
Additionally, some notes can be added here that will not affect the QCR score such as: ‘This community Pepper Station Condo's is often confused with another nearby community Piper Station Townhouses.’
A few of the most common and major community Restrictions will be noted in the Document Review section as to the major ones that are not allowed. These will include but not be limited to: ‘private streets, no parking on street’; ‘dog breed restrictions’; ‘figurines or decorative items in yard restrictions’, ‘sheds are not allowed’, etc. Fines for violations will be briefly discussed in the Document Review section.
An additional note will be the Turn Over Date. The date the community was turned over to the Homeowners from the original Developer for Homeowner control will be noted in this section, as the ‘Turn Over Date’ (TOD). Other notes, if applicable, may be if the original Developer sold the property or foreclosed on the property/development/project. These potential notes, if applicable, will be added here.

An overall rating of 1 to 10 will be assigned for this section. Again 10 being the best and highest score.

*End of section on Document Review

### IV. Financials, Money Management

B. Budget, Audit and/or Reserve Study information

### Financial Review

The community budget process will be outlined in what will be called the “Financial Review”. This section can or may be reviewed by an Accountant or a community expert with financial credentials, a Board member, or Budget committee member before being downloaded.

Note: When a full 3^{rd} party evaluation (by an Accountant) has occurred a ‘Verified’ symbol will be noted in that section.

Documents and procedures that can and may be posted:
Any current budget can be downloaded and displayed in this section.
The community audit process will be outlined in this section as to its periodic occurrence, ie. Every 3 years or annually. A brief overview of the audit results can be displayed in this section when available.
The community Reserve Study process and a brief overview of the results of the Reserve Study may be outlined in this section. Additionally, the Reserve Study's periodic occurrence will be noted.
Notes of low funds for amenity replacements will be noted.
Overall community finances will be briefly reviewed and noted here: Underfunding Reserves or Overfunding Reserves will be noted in this section, as well.
A history of Special Assessments will be noted here, ie. ‘2009-$50.00 Spec. Assessment for Tennis court repair.’ Or ‘This community to date and in its history has not had a Special Assessment imposed on the members of the Association.’
Loan information is noted here. If the community leaders felt it necessary to take out a loan for any reason and what it was used for and what year, this info shall be noted in the Financial Review.

Although the Budget, Audit and Reserve Study information if available will be downloaded to the QCR they may not be posted. However, they do not necessarily have to be posted to the QCR in their entirety. They may be reviewed and rated by a community expert with financial credentials and referenced as to their existence and dates. It will be a decision made by the Board of Directors as to whether or not they want their community financials on the QCR. They may have a statement saying, ie. ‘upon request the current budget and or other documents can be reviewed by a potential home purchaser with a five day notice; location to be determined and decided by these parties.’

If the periodic timeline for financial audits is not noted in the governing documents, there will be a demerit on the scoring section of Financial Review. Audit timelines should be spelt out in the original documents typically, ie. ‘Financial record audits shall be conducted every three (3) years by a Certified Public Accountant.’ If the audit timeline information and requirement are not noted and not required in the original documents this should reflect in the QCR rating. To further clarify, the lack of a timeline for audits to be conducted could and should lower a Financial Review perfect 10 score to a 9 or lower, depending on the Community Consultants' expert opinion and combined review of all financial documents and records.

The above items: Audits, Budgets and Reserve Studies, but not limited to, will reflect on the overall score on this section named the Financial Review. An overall rating of 1 to 10 will be assigned for this section. Again 10 being the best and highest score.

*End of Section on Financial Review

### V. Job Performance Review of Committee and Board Members

### C. Policies and Follow Through of Acting Current and Past Board of Directors, Committee Chairs, and the Architectural Control Committee

### Committee Performance Review

An overall brief analysis of past and current volunteers within their time frame of leadership shall be rated as to how many projects were completed under their direct supervision. This will not be expressed with names of these community leaders, but as a timeline of leadership, ie. ‘during the years of 2012 to 2014 the following was accomplished: New Swing sets were added.’

This will include for another example, ‘During the year 2009 the community's Board of Directors approved a community wide special assessment for $40 to each member of the association (homeowners) to fund the resealing of the parking lot near the pool. This project was Board approved; the parking lot was resealed and anticipated life expectancy is to 2035.’

Other examples could be, ‘During the year of 2008 the Architectural Review. Committee reviewed and established an Architectural Design Guide for the community for further clarification of the governing documents. This Architectural Design Guide was approved by the Board of Directors in the year 2008 at the Board meeting of May 27^{th}. It was shared with the members of the association at the June 2008 Annual meeting. This Document is recorded with the communities governing documents in the County records.’

More detailed information can be added on a case by case basis by a third party consultant especially noting exceptionally run communities for example the below 3^{rd} party consultant outline and comments: ‘Report submitted on Aug. 12, 2002, by Community Consultant, George F. This is a very active homeowner controlled community with many engaged volunteers that rotate in throughout different committees on a yearly basis. The community elections are very important and the homeowners take their community involvement very seriously. There are many active social committees and a very interactive community website and their own FaceBook page sponsored by this community. This community also sponsors its own Swim Team that competes within the southern swim league. There are many fully volunteer staffed committees which include: Landscape, Social, Pool, Architectural Review, Budget, and Ad Hoc (special events). To apply for a volunteer committee position there is an application and interview process. Most Board members have started on various committees before being considered for a candidacy position on the Board of Directors. This is an exceptionally run community by its homeowners.’

An overall rating of 1 to 10 will be assigned for this section. Again 10 being the best and highest score.

*End of section on Committee Performance Review

### VI. Professional Management Company Involvement

### D. Community Property Management Selection and Their Performance

### Management Company Performance Review & History

If there is a high turn over of homes and homeowners in a specific community a lot of the word of mouth community history is lost if not recorded. Typically, it is not documented anywhere. This is the section of the QCR report that will document this information. The name of the community management companies or self-managed time frames and their work timelines will be noted in this section. This information is important and often times lost. However, Insurance Companies would benefit from this information when they are researching insurance claims and need to speak to a ‘previous management company.’ They'll be able to find this info on the QCR.

For example:

Happy Trails Mgt. History:
1. Developer Control—self managed by Developer's management staff from 1998 to 2002
2. SSA HOA Management—start date Jul. 11, 2002 to May 15, 2014
   Notes: Developer Control to Homeowner Control—process
   Increased reserves 20% in 3 years **2003 to 2006.
   SSA Mgt. Company dissolved in May 2014
3. WGA Association Management—Start May 15, 2014 to present (July 2014)
   Reserve study conducted November 2014
   Consistent management with no issues

Any notes of self managed time periods will be noted in this section.

An overall estimate of how many violations per month or per year, are generated and sent to members (homeowners) of the association may also be noted in this section. This will be an indicator of the management style of the community and/or the aesthetic appearance of the community.

An overall rating of 1 to 10 will be assigned for this section. Again 10 being the best and highest score.

*End of section on Management Company Performance Review & History

### VII. Amenity Information

### E. Amenities and Their Life Expectancy, Additionally Whether All Planned Amenities Have Been Installed Per the Original Community Layout

### Community Amenities Review

All community amenities will be listed in this section: ie. Tennis courts, swimming pool, front entrance monument, golf course, etc.

Some examples of this additional information or notes are:
There is only a front brick wall in this community that runs the perimeter of the front property line approximately 200 yards long. No other amenities.
All roads are owned by the community and must be maintained by the community. Reserves for this maintenance expense are being set aside. Please note currently this is a community expense.
All roads are owned by the community, but maintained by the County, (or State, or Town.)
All original amenities were installed by the original developer as laid out in the original community documents.
Reserve Study conducted in 2009, updated every 5 years. Per this study community's swing set to be replaced in 2020.
The community and the HOA are only the homes. All amenities are a separate entity, ie. The golf course and tennis courts. Please see the Stone Ranch Club for a separate membership.

An overall rating of 1 to 10 will be assigned for this section. Again 10 being the best and highest score.

*End of section on Community Amenities

### VIII. Future Neighbor Information

### F. Testimonials From Individual Property Owners

### Meet the Community Neighbors!

Testimonials will be essential as they will give the subscriber a real good snap shot of the community life. Additionally, statements & testimonials are monitored by Community Consultant before download allowed for foul language or inappropriate statements:

Some examples of current homeowner testimonials are:

### EXAMPLE 1

I'm a homeowner in Happy Trails and moved here from out of state. This is a quiet community and our peaceful moon lit nights are always enjoyed. We have many nights filled with long quiet walks without loud noise. From: Jenny Homeowner #1

### EXAMPLE 2

Our community is active and busy. Many homeowners & volunteers come out to make sure every night we have a fun filled party around the pool and clubhouse. All are welcome at Blue Sky Ranch Homes! From: Kathy Homeowner #2

### EXAMPLE 3

We moved into Diamond Estates and wanted to ensure the community management company was fully involved with the community on every aspect. Typically we do not have any outside involvement other than our management company, and we especially do not allow community or individual yard or garage sales. We do not volunteer our time and most of our neighbors are in the same category. We pay more for our management service, but feel it is well warranted. From: Eric Homeowner #3

### EXAMPLE 4

We moved into Mountain Top Estates to get away from the big city hustle and bustle. Our community is comprised of 50 total homes. With only a few amenities, our security gate and front entrance, which run very smoothly each property owner has a feel of individually being on their own estate. There is very little neighbor to neighbor involvement. We have a small Board of Directors, mostly retirees, that ensure the community's daily business functions properly and only have an Accounting Package with our HOA Mgt. Company. Each homeowner is responsible for their own yards and upkeep or will get a call from the Board President. *To date this has not happened. Please feel free to call me for more community information or visit our community website at www.MountainTopEstates.com. From: George B.—Current Board President 1996 to 1999 Homeowner #4

### EXAMPLE 5

My wife and I purchased one of the first homes to be built in Green Acres. The Developer has turned over the operation of the association to the homeowners. We are self-managed and could use a few more volunteers to help with maintaining the pool and grounds. From: Harold J.—current Board Treasurer Homeowner #5

### EXAMPLE 6

We purchased our home without checking the QCR before we moved in. The community is friendly and acceptable to us. However, we did expect more social functions and did not realize volunteers ran the HOA & social functions. There are very few volunteers in our community and therefore no social functions. Wish we had checked the QCR rating before we purchased. We found out after we moved in that Peppers Glen HOA across the way has many social functions and many more volunteers to run their functions. Too late now. From: Tracy Homeowner #6

An overall rating of 1 to 10 will be assigned for this section. Again 10 being the best and highest score.

*End of section on Meet the Community Neighbors!

### IX. Added Notes

### G. Areas of Concern

### Additional Notes

Any lawsuits placed against the Association will be noted here. Any Loans to cover for amenity up keep or other items will be noted here & why. Automatic 10 in this section with no notes. If there is a concern that adversely affects the community the 10 is lowered per merits as to the Community Consultant's opinion.

*End of section of Additional Notes

*End of sections of all of the subcategories.

### X. CONCLUSION

### Final QCR Scores and Tabulations

CLARIFICATION & ‘Verified’ Symbol: The 3^{rd} Party Consultants which are engaged to perform the review of each community will perform the analysis. They can solely perform the review or they may be aided by the communities Leaders and Board of Directors. Each community Board of Directors can submit their own evaluations of each noted Review Section with a final review by the Community Consultant. On the other hand, when an industry professional (lawyer, accountant) evaluation has occurred upon request in the Document Review or Financial Review section a ‘Verified’ symbol will be connected and noted in that section.

For example, a community that has the professional review all documents and has the expert HOA attorney retrieve and review the community's recorded documents from the County records can receive a near perfect rating for that section and a ‘Verified’ symbol. Additionally, with the Financials should an HOA accountant review the financials another near perfect rating can occur for that section.

End of this section.

### XI. Example of QCR

The final QCR number & score is tabulated by averaging each section

Below is the QCR rating system and report for Happy Trails Community

| Evaluation Section | | Score | Notes |
|---|---|---|---|
| 1. | Document Review | 8 | Audit not noted in Docs. |
| | | | ‘Verified’ |
| 2. | Financial Review | 7 | over budget last year |
| | | | Verified′ |
| 3. | Committee Performance Review | 9 | Volunteers very involved |
| 4. | Management Company | 7 | A few lingering issues |
| | Performance Review & History | | |
| 5. | Community Amenities Review | 6 | Update pool work needed |
| 6. | Meet the Community Neighbors! | 9 | Social events planned |
| 7. | Additional Notes *add 10, unless | 10 | no unusual issues |
| | issue | | |

Total score: 56 **for an average of =8 QCR ‘Verified’
Note:
**Professionals Reviewed all Documents and Financials which reflects in the high score of ‘8’ in the overall rating.
OVERALL QCR SCORE = 8.00 w/‘Verified’
**Note:
Average QCR score within system for most communities is a 6.75
Restrictions for this community area standard, one highlight that pets weight limit is 50 lbs.

The above is the example of an outline and description of the proposed QCR scoring system based on this hypothetical community's Community Profile within the QCR system.

### FINAL CONCLUSION OF DESCRIPTION OF QCR SYSTEM

### Additional Subscriber Aid

This OCR score is intended as an aid to homebuyers/subscribers only and not the final determining factor of whether a property should be purchased within the subject community or not. This is only intended as a helpful format of information for subscribers that are not familiar or need to become more familiar with the subject property, community rules, and community before the subscriber purchases the home.

The above Patent Description is the outline and description of the proposed QCR scoring system based on each communitys' Community Profile within the QCR system.

### How It Will Work:

This will work within a few different formats:

A subscriber can look up a community via computer, web site, or cell telephone application or Geo Locator/GPS and retrieve the QCR score, with following information 1) community name and zip code or GPS location; 2) location, price range, zip code, QCR score. 3) amenities offered and QCR score. The search will retrieve the selected communities based on data selected. Then the buyer can further retrieve more detail information when prompting the system. To be more clear, the basic community profile and more detailed information will be available. If a potential subscriber wants more detailed information they can then retrieve additional detailed information from each of the 7 Review sections.

### Function of the QCR System

Therefore a homeowner can use the QCR system to either check the score of a potential community where they are purchasing the home or look for a community with a QCR score that fits their needs. If a community has an average or high score there should be no need for a concern. If there is a low score, of a 2 or 3, there should be some cause for concern and a potential homebuyer would want to pursue some more investigation into that particular community and why the score is low. However, when a subscriber finds a community that they are comfortable with as to the QCR rating they then will also be able to burrow into a section that has for rent or for sale by individual owners, or other inventory within that community, etc.

This is an additional aid for the buying process of home ownership. It's not always just the home that should be considered when purchasing, but also the community and how it functions with its rules and regulations; how it is managed; how the assessments are spent, all should be a big consideration, as well. This outline of a community profile and the QCR scoring system along with neighbor testimonials should be of a great value for the decision making process when buying a home. It will be a ‘glimpse’ to the actual living and lifestyle of the community before buying a home there.

In closing, I am unable to provide sketches or pictures as this is a web or app for a phone. I do have a proto type of this website and app that can be viewed by you. I can provide the link and password as of now this information is not on a public domain and is privately viewable.

1. I have searched various records, websites, search engines at my library computers and have not found anything similar to this patent and service for homebuyers.
As I explain in my patent specification and patent abstract there is no other service like this available to a buyer or real estate agent.
Most real estate services will provide a listing of house within a community with little or no community information. This Quality Community Review (QCR) will provide community information via a computerized data base that can be accessed by homebuyers, real estate agents.
There are companies that will provide community documents via a web site, but they do not analyze and rate them. They do not provide financial information. These are public records that the QCR will make available to the homebuyer.
Communities do have their own websites and quite a few do. However this QCR will be an independent 3^{rd} party rating and information gathering service. There will be no connection to the community which will be completely objective 3^{rd} party reviews of the community.
This will be GPS or Geo Locator driven so buyers can access community information via the QCR application which no other company has that function.
The data collected and information will be reevaluated on a time frame of approximately 12 months so there won't be old information within the QCR system.
This QCR will employ people and create jobs. It will open up an industry that links the Real Estate Market and the Community Management Market together with a third in between new industry. The QCR rating system and information data base. It will additional enable physically challenged people an opportunity to work as a lot of the data entry is computer based.
This product will be in every major metropolitan city and require staffing and consultants to service the customers of the QCR product.
I do believe the market place is now ready for this new system and QCR especially with the advances in technology that will enable the data and info to be available on the computer & phones & watches in the future.
As this will be the future of real estate shopping and buying houses.
